(19) United States
(12) Patent Application Publication
(10) Pub. No.: US 2016/0172174 A1
(43) Pub. Date: Jun. 16, 2016

(54) MATRIX FILM FORMING DEVICE

(71) Applicant: SHIMADZU CORPORATION, Kyoto-shi (JP)

(72) Inventor: Kazuteru TAKAHASHI, Kyoto-shi (JP)

(73) Assignee: SHIMADZU CORPORATION, Kyoto-shi (JP)

(21) Appl. No.: 14/820,622

(22) Filed: Aug. 7, 2015

(30) Foreign Application Priority Data
Dec. 12, 2014 (JP) 2014-251620

(51) Int. Cl. H01J 49/04; B05D 1/04; B05B 5/16

(52) U.S. Cl. CPC H01J 49/0418; B05B 5/16; B05D 1/04

(57) ABSTRACT

A matrix film forming device including a first electrode plate including a mounting surface on which a sample plate P is mounted; a second electrode plate arranged facing said mounting surface; a nozzle which sprays a liquid containing a matrix substance by an electrospray process into the space between the first electrode plate and the second electrode plate and is arranged such that the first electrode plate and second electrode plate are not present over the central axis of the spray stream; and an electric field forming device which forms, between the first electrode plate and the second electrode plate, an electric field causes liquid drops containing charged matrix substance contained in the spray stream to move toward said mounting surface.

### TECHNICAL FIELD

The present invention relates to a matrix film forming device for forming a film of matrix substance on a sample plate used for performing analysis of samples in a mass analysis device (MALDI-MS) comprising an ion source based on matrix assisted laser desorption/ionization (MALDI).

### BACKGROUND ART

MALDI is a technique for analyzing samples which do not readily absorb laser light or samples such as proteins which are easily damaged by laser light, wherein a substance which readily absorbs leaser light and is easily ionized is mixed in advance into the sample as a matrix, which is then irradiated with laser light to ionize the sample. Normally, the matrix is added to the sample in a liquid state, and this matrix incorporates the substance to be analyzed which is contained in the sample. Then, once the matrix dries, crystal granules form, which contain the substance to be analyzed. When these are irradiated with laser light, the substance to be analyzed can be ionized due to interactions between the substance to be analyzed, the matrix and the laser light. MALDI allows macromolecular compounds of large molecular weight to be analyzed without much cleavage thereof, and is also well suited for microanalysis, and has thus been widely employed in recent years in fields such as life sciences.

In mass analysis using MALDI as described above, by narrowing the spot diameter of the irradiated laser light and moving the irradiation location in relative fashion over the sample, it is possible for example to obtain an image (mass analysis image) representing the intensity distribution of ions having a given mass number on the sample. Such devices are known as mass spectrometer microscopes or microscope mass spectrometers, and are seen as promising especially in the biochemical field, medical field and the like, for the application of obtaining distribution information on proteins contained in cells in vivo.

When using MALDI to obtain a mass analysis image (i.e. when performing two-dimensional mass analysis imaging), a sample (e.g. a biological tissue section) is affixed onto the sample plate used in the MALDI-MS, after which a matrix film is formed on the sample plate. Here, it is preferable to add the matrix to the sample plate as uniformly as possible. Thus, in the prior art, methods such as spraying, dropwise addition or vapor deposition of matrix in a liquid state have been employed as the method of application to the sample plate.

### PRIOR ART LITERATURES

### Patent Literatures

(Patent literature 1) Japanese Unexamined Patent Application Publication 2013-137294

### SUMMARY OF THE INVENTION

### Problem to be Solved by the Invention

However, with the spray-based method and the method based on dropwise addition, there is the problem that the size of drops of matrix adhering to the sample plate becomes relatively large, making it difficult to form small crystal granules on the sample plate, and a result, it is not possible to achieve a high spatial resolution of two-dimensional mass analysis imaging. Furthermore, with the method based on vapor deposition (for example, see Patent Literature 1), while it is possible to form a matrix film of small crystals, since the matrix is heated to a high temperature during vapor deposition, depending on the matrix substance, there is the possibility that it will decompose due to the heat. Furthermore, since it is necessary to place the sample plate under high vacuum during vapor deposition, there is the problem that the operation of drawing the vacuum deposition chamber to a high vacuum occurs every time a sample is prepared, taking up time and effort.

In this connection, in recent years, a method has been proposed in which a matrix film is formed by applying a matrix substance to the sample plate by means of an electrospray deposition (ESD) process using electrospray, whereby a liquid material is electrically charged and sprayed in a microdrop state.

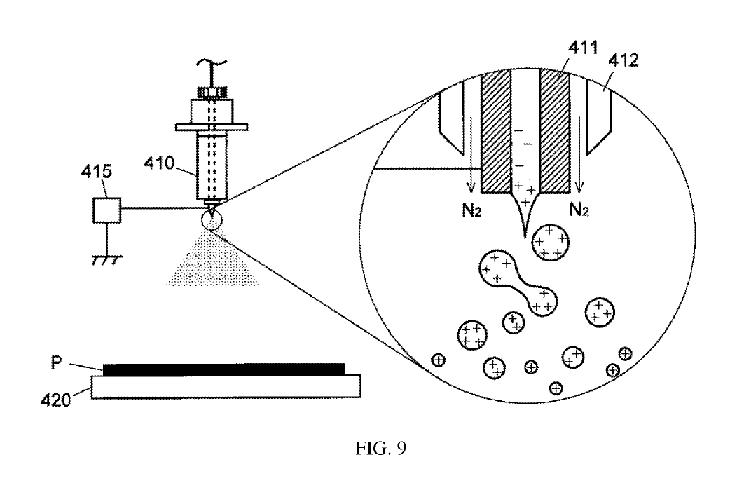

FIG. 9 is a schematic diagram of a matrix film forming device using the ESD process. This device comprises a horizontal plate platform 420 on the top surface of which a sample plate P is placed, and a nozzle 410 arranged with its tip facing downward above the plate platform 420. Nozzle 410 comprises a thin tube (capillary) 411 and a nebulizer gas tube 412 which is coaxial with the capillary 411 and is arranged so as to surround the capillary 411 as an outer tube, and a direct current high voltage of several kV to several tens of kV is applied by voltage application unit 415 to the capillary 411 itself or to an unillustrated metal tube provided around the capillary 411. Under the influence of the electric field formed due to this voltage, the matrix liquid (matrix substance dissolved in a solvent) which flows through the capillary 411 is positively or negatively charged, and is ejected in the form of charged microdrops with the aid of a nebulizer gas (usually, N₂ gas) which is ejected from nebulizer gas tube 412. The ejected microdrops are finely broken up by the Coulomb repulsive force of the imparted electric charge. The flow (spray stream) of microdrops ejected from the capillary 411 advances while spreading in a substantially round conical shape toward the central axis of the plate platform 420. The microdrops then adhere to the top surface of the sample plate P arranged below the nozzle 410. A sample (for example, a thinly sliced biological tissue section) is affixed in advance to the sample plate P, and the substance to be analyzed which is contained in the sample is taken up into the matrix liquid through the film forming process described above. Once the solvent in the matrix liquid dries, a matrix film, comprising crystal granules containing the substance to be analyzed, forms on the sample plate P.

This sort of ESD process, just as the vapor deposition process, makes it possible to form a matrix film based on microcrystals, does not require heating the matrix to a high temperature, and does not require a high vacuum during film forming, and thus has the advantage of allowing matrix film forming on the sample plate to be performed easily and quickly.

However, with film-forming based on conventional ESD as described above, not just the charged matrix liquid but also impurities such as neutral particles contained in the spray stream adhere to the sample plate, so it may be difficult to form a matrix film of high purity.

The present invention was made in view of the aforementioned points, its object being to provide a matrix film forming device which makes it possible to form a matrix film composed of microcrystals and to form a matrix film with low content of impurities such as neutral particles.

### Means for Solving the Problem

The matrix film forming device of the present invention, made to resolve the aforementioned problem, is a device for forming a film containing a matrix substance on the surface of a sample plate, characterized in that it comprises:

a) a first electrode plate comprising a mounting surface on which said sample plate is mounted;

b) a second electrode plate arranged so as to face said mounting surface;

c) a nozzle which sprays a liquid containing a matrix substance by means of an electrospray process into the space between said first electrode plate and said second electrode plate, and which is arranged such that said first electrode plate and said second electrode plate are not present over the central axis of the spray stream; and

d) an electric field forming device which forms an electric field between said first electrode plate and said second electrode plate so as to cause drops of liquid containing said matrix substance, which have been electrically charged and are contained in said spray stream, to move toward said mounting surface.

In the matrix film forming device of the present invention, as described above, when spraying the liquid containing the matrix substance (the matrix liquid) from the nozzle by the electrospray process, the central axis of the spray stream is made to pass between the two electrode plates (i.e. the first electrode plate and second electrode plate) and not intersect either of the electrode plates. The charged drops of matrix liquid passing between the two electrode plates are made to move from the second electrode plate toward the first electrode plate by the effect of the electric field formed by the electric field forming device, thereby causing the matrix substance to be deposited on the sample plate mounted on the first electrode plate. Here, only charged matrix liquid drops are attracted toward the first electrode plate, while neutral particles which carry no charge pass between the two electrode plates without being attracted to the first electrode plate. Thus, neutral particles contained in the spray stream can be prevented from adhering to the sample plate, making it possible to form a matrix film with low content of impurities.

It will be noted that in the present invention, the fact that the second electrode plate is “arranged so as to face” the mounting surface is not necessarily limited to a state where the two are directly opposite and includes for example the state where the second electrode plate is tilted in relation to the mounting surface. In this case, the angle formed by the mounting surface and the second electrode plate is preferably 30 degrees or less, with 10 degrees or less being more preferable.

Furthermore, the center of the second electrode plate need not necessarily be positioned on the normal line passing through the center of the mounting surface.

Namely, it suffices if the first electrode plate and second electrode plate are arranged so as to form an electric field between the mounting surface of the first electrode plate and the surface of the second electrode plate facing the spray stream when a direct current voltage is applied between the two, so as to cause the charged liquid drops in the spray stream to move in a direction which intersects the central axis of the spray stream.

In the matrix film forming device according to the present invention described above,

said nozzle can comprise

e) a capillary having a tubular shape, through which liquid containing said matrix substance flows from the base end side toward a liquid drop spray opening provided on the tip end side; and

f) a nebulizer gas ejection channel which is a channel running parallel to said capillary and through which nebulizer gas is ejected in the vicinity of said liquid drop spray opening,

and the matrix film forming device can further comprise

g) a voltage application device which applies a direct current voltage to said capillary.

With this sort of configuration, the matrix liquid inside the capillary is charged by the action of the electric field formed at the tip end part of the capillary due to the voltage applied by the voltage application device, and this charged matrix liquid is sheared by the nebulizer gas and ejected from the liquid drop spray opening.

In a matrix film forming device with this sort of configuration, the nozzle can be made into a double tube structure consisting of the capillary as an inner tube and a nebulizer gas tube as the outer tube. In this case, the space between the outer circumferential surface of the capillary and the inner circumferential surface of the nebulizer gas tube functions as the nebulizer gas ejection channel.

Alternatively, in the matrix film forming device of the present invention described above,

said nozzle can comprise

h) a capillary having a tubular shape, through which liquid containing said matrix substance flows from the base end side toward a liquid drop spray opening provided on the tip end side,

and the matrix film forming device can further comprise

i) an opposed electrode arranged at a position opposite the tip end of said nozzle; and

j) a voltage application device which applies a direct current voltage between said capillary and said opposed electrode.

A matrix film forming device comprising the above configuration performs spraying of charged liquid drops based on so-called nanoelectrospray. With this sort of configuration, by imparting a large potential difference between the capillary and the opposed electrode with the voltage application device, a strong electric field is formed near the liquid drop spray opening. The liquid containing the matrix substance is then charged by this electric field and separated into positive and negative ions. Ions having a polarity which is attracted to the opposed electrode (i.e. ions of the matrix substance) are pulled out and sprayed from the nozzle in a state of dissolution in the liquid.

Since the spray stream has faster flow velocity the closer it is to the nozzle and since the spread of the spray is small, when the electric field formed by the electric field forming device is relatively weak, the liquid drops containing the matrix substance will not move toward the mounting surface of the first electrode plate until they have moved away from the nozzle to a certain extent, as a result of which the liquid drops may adhere in biased fashion to areas further from the nozzle and from the vicinity of the center of the sample plate. Conversely, when the electric field is relatively strong, liquid drops containing the matrix substance which are contained in the spray stream will be rapidly attracted to the first electrode plate, and as a result, the liquid drops may adhere in biased fashion to areas of the sample plate closer to the nozzle.

Thus, in the matrix film forming device of the present invention described above, it is preferable to additionally provide

k) an electric field intensity difference forming device which changes the intensity of said electric field over the central axis of said spray stream in accordance with the distance from the tip end of said nozzle.

Based on this configuration, in the space between the two electrode plates, it is possible to change the magnitude of the force which draws the liquid drops containing the charged matrix substance toward the first electrode plate in accordance with the distance from the nozzle. It is thereby possible to prevent the occurrence of nonuniformities in film thickness due to biased adhesion of the liquid drops in a particular region of the sample plate, allowing one to form a matrix film of uniform thickness.

Furthermore, it is preferable for the matrix film forming device of the present invention described above to additionally comprise:

l) a liquid drop size adjustment device which adjusts the size of drops of liquid containing said matrix substance which adhere to said sample plate by changing the potential difference between said first electrode plate and said second electrode plate.

### Effect of the Invention

With the matrix film forming device of the present invention having a configuration as described above, it is possible to prevent the deposition of neutral particles on the sample plate and to form a matrix film with low impurities.

### BRIEF DESCRIPTION OF THE DRAWINGS

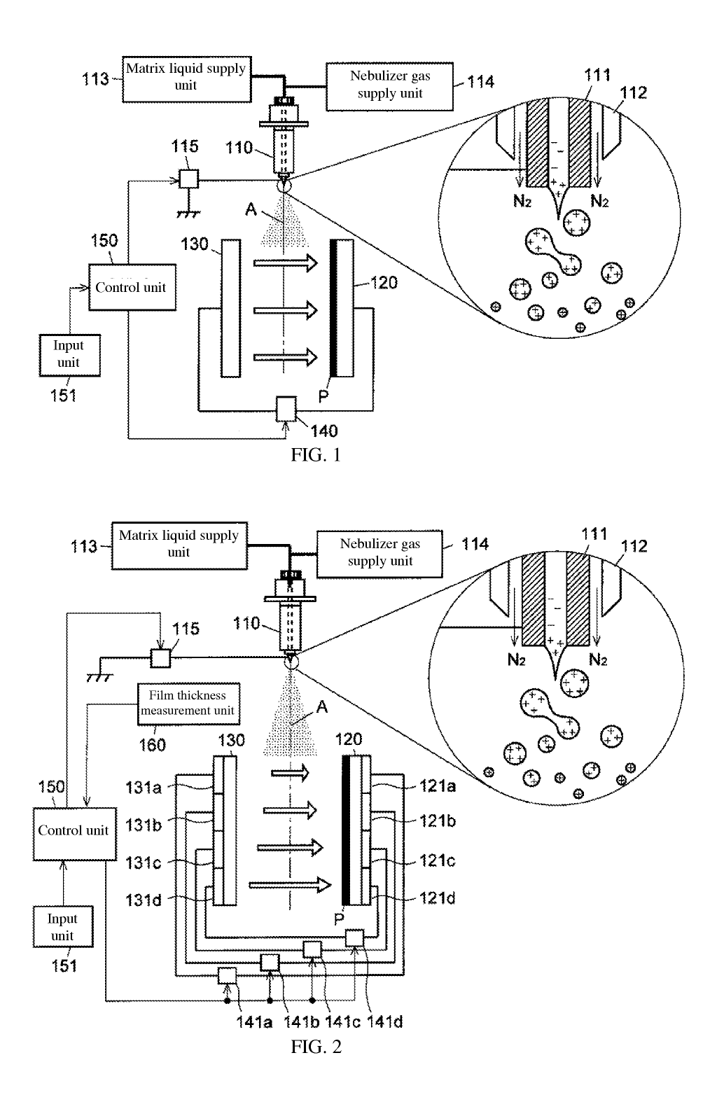

(FIG. 1) A schematic diagram of a matrix film forming device according to a first embodiment of the present invention.

(FIG. 2) A drawing illustrating a modified example of the matrix film forming device according to the same embodiment.

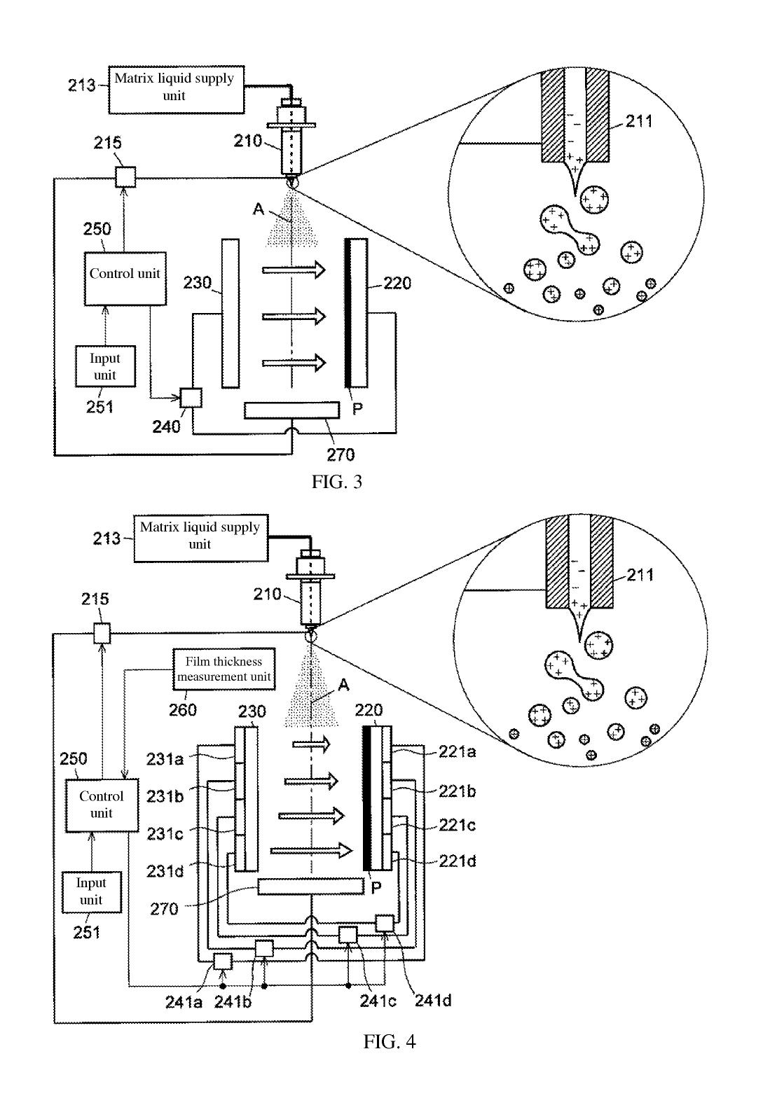

(FIG. 3) A schematic diagram of a matrix film forming device according to a second embodiment of the present invention.

(FIG. 4) A drawing illustrating a modified example of the matrix film forming device according to the same embodiment.

(FIG. 5) A drawing illustrating another example of the configuration of the matrix film forming device according to the present invention.

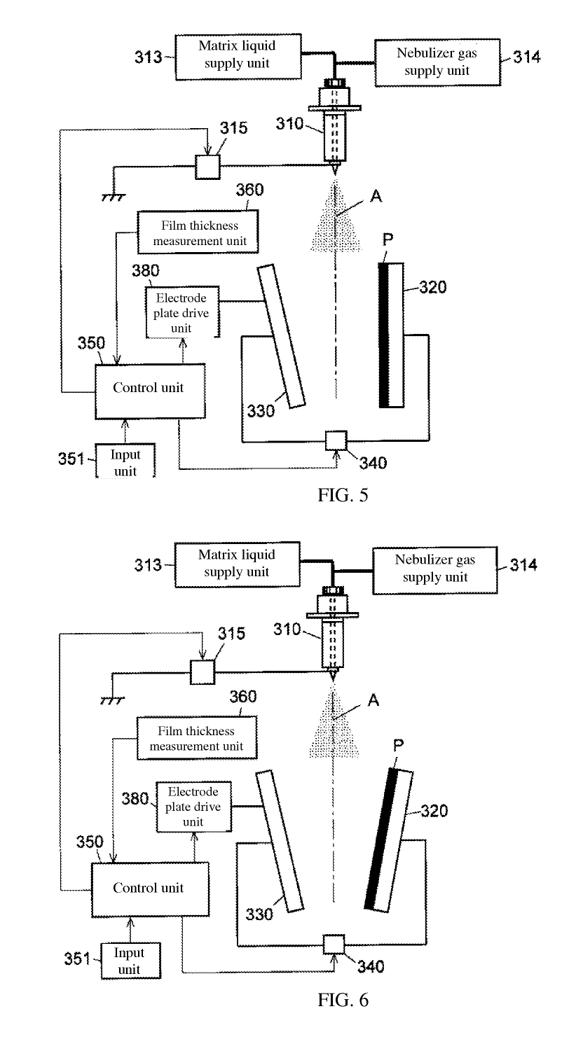

(FIG. 6) A drawing illustrating yet another example of the configuration of the matrix film forming device according to the present invention.

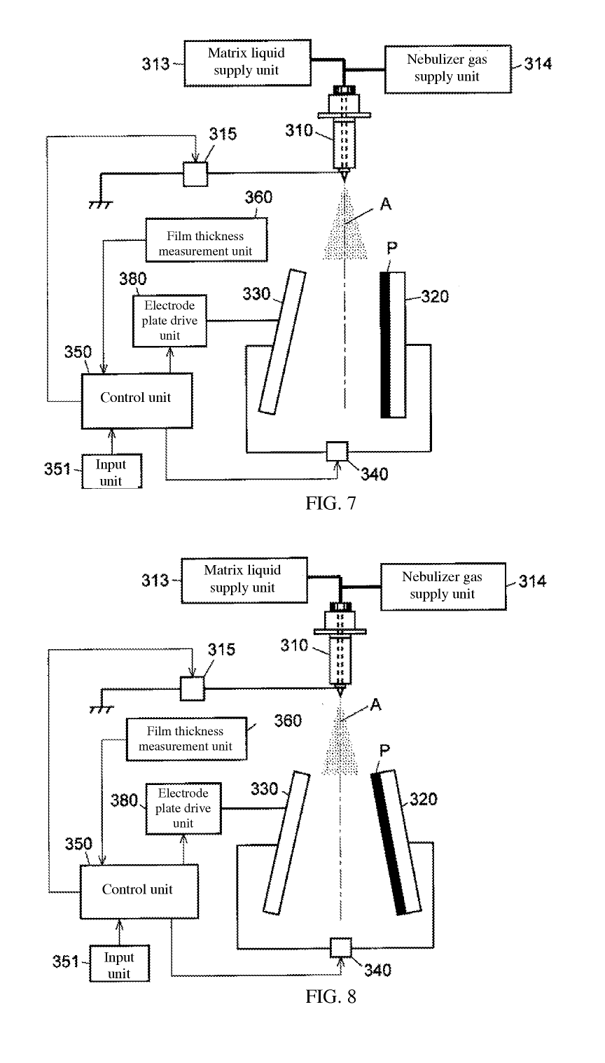

(FIG. 7) A drawing illustrating a modified example of the device of FIG. 5.

(FIG. 8) A drawing illustrating a modified example of the device of FIG. 6.

(FIG. 9) A schematic drawing intended to explain a conventional method of forming a matrix film on a sample plate using ESD.

### DETAILED DESCRIPTION OF THE EXEMPLARY EMBODIMENTS

### Embodiment 1

FIG. 1 is diagram of the essential parts of a matrix film forming device according to a first embodiment of the present invention. This matrix film forming device comprises a nozzle 110 for spraying a liquid (matrix liquid) containing a matrix substance, a first electrode plate 120 on which a sample plate P is mounted, and a second electrode plate 130 arranged opposite the first electrode plate 120.

The area surrounded by the circle on the right side in FIG. 1 illustrates in enlargement the longitudinal cross-section of the tip end part of the nozzle 110. As shown in this drawing, the nozzle 110 has a double tube structure comprising a capillary 111 and a nebulizer gas tube 112 arranged coaxially with the capillary 111 so as to surround the capillary 111 as an outer tube. Matrix liquid is supplied to the capillary 111 from matrix liquid supply unit 113. Furthermore, a nebulizer gas, which is an inert gas (usually, nitrogen gas) is supplied from nebulizer gas supply unit 114 into the space between the outer circumferential surface of capillary 111 and the inner circumferential surface of the nebulizer gas tube 112. Furthermore, a direct current high voltage of several kV to several tens of kV is applied by a spray voltage application unit 115 to the capillary 111 itself or an unillustrated metal tube provided around it.

The first electrode plate 120 and second electrode plate 130 are metal flat plates arranged parallel to each other and about 15 mm to 30 mm apart, and a direct current voltage of about ±1 kV to ±3 kV is applied to the space between the two by a deposition voltage application unit 140 (corresponding to the electric field forming device of the present invention). A sample plate P, usually composed of electroconductive material, is mounted on the surface (plate mounting surface) of the first electrode plate 120 facing the second electrode plate 130. As the sample plate P, a slide glass shaped plate of about 26 mm×76 mm, a MALDI plate whereof one side is about 80 mm to 130 mm or the like can be used. Tab-like retaining members, fashioned for example from an insulator, are provided on the plate mounting surface, and a sample plate P to which a sample (for example, a biological tissue section) has been attached in advance, is secured to the first electrode plate 120 by means of these retaining members.

The spray voltage application unit 115 and deposition voltage application unit 140 are controlled by a control unit 150 comprising a computer, etc., and an input unit 151 comprising buttons, dials, a keyboard, etc. for inputting instructions from a user is connected to the control unit 150.

In the matrix film forming device of the present embodiment, the nozzle 110 is installed with its tip end facing downward, and the first electrode plate 120 and second electrode plate 130 are arranged parallel to each other below the nozzle 110 so as to sandwich the central axis A of the spray stream formed by the nozzle 110.

When a film is formed by the matrix film forming device of the present embodiment, matrix liquid which has flowed from the matrix liquid supply unit 113 to the tip end of the capillary 111 is charged to some charge (in this example, a positive charge) under the influence of the electric field generated by the voltage applied by the spray voltage application unit 115. In this state, the matrix liquid, with the assistance of nebulizer gas ejected from the tip end of the nebulizer gas tube 112, turns into microdrops and is ejected. The ejected microdrops are finely broken up by the Coulomb repulsive force of the imparted electric charge. In this way, the matrix liquid is sprayed downward from the tip end of the nozzle 110, and the spray stream enters the space between the first electrode plate 120 and the second electrode plate 130 while spreading in a substantially circular conical shape. Here, a direct current voltage is applied between the first electrode plate 120 and the second electrode plate 130 by the deposition voltage application unit 140 so that the first electrode plate 120 side becomes a negative electrode. Thus, the microdrops of the matrix liquid having a positive charge which have entered into said space are attracted toward the first electrode plate 120 under the effect of the electric field formed by this voltage application, leave the flow of the aforesaid spray stream, and adhere to the surface of the sample plate P. On the other hand, neutral particles which have no electric charge proceed downward with the flow of the spray stream without being attracted to the first electrode plate 120, and continue to pass through the aforementioned space, and thus these neutral particles do not adhere to the sample plate P.

In this way, with the matrix film forming device according to the present embodiment, it is possible to deposit only microdrops of charged matrix liquid on the sample plate P, allowing one to form a matrix film with lower content of impurities than in the prior art. Furthermore, here, by having the control unit 150 change the magnitude of the voltage applied by the deposition voltage application unit 140 in accordance with user instructions given via input unit 151, it is also possible to control the maximum size of drops of the matrix liquid made to adhere to the sample plate P (in this case, the control unit 150 corresponds to the liquid drop size adjustment device of the present invention). In this case, the maximum size of drops of the matrix liquid adhering to the sample plate P can be made smaller by making the voltage applied by the deposition voltage application unit 140 smaller.

In the above example, the strength of the electric field formed through the application of voltage by the deposition voltage application unit 140 is substantially uniform in the space between the first electrode plate 120 and second electrode plate 130, but the invention is not limited thereto and may be configured, for example, so that the strength of the electric field in said space changes according to the distance from the nozzle 110. An example of the configuration for such a case is shown in FIG. 2.

In this example, on the outer surfaces of the first electrode plate 120 and second electrode plate 130 (i.e. the surfaces on the other side from the surfaces which face the spray stream), multiple electrodes 121a through d and 131a through d are attached in a direction parallel to the central axis A of the spray stream, and separate deposition voltage application units 141a through d are provided between the electrodes provided at positions corresponding to the electrode plates 120 and 130. Furthermore, the magnitude of the voltage applied between the electrodes is controlled by control unit 150 such that the potential difference between the first electrode plate 120 and second electrode plate 130, for example, becomes small closer to the nozzle 110 and larger further away from the nozzle 110.

Namely, deposition voltage application unit 141a is provided between electrodes 121a and 131a which are provided at a location closest to the nozzle in FIG. 2; deposition voltage application unit 141b is provided between the second closest electrodes 121b and 131b; deposition voltage application unit 141c is provided between the third closest electrodes 121c and 131c; and deposition voltage application unit 141d is provided between the electrodes 121d and 131d furthest from the nozzle. Assuming the magnitudes of the application voltage produced by these deposition voltage application units 141a, 141b, 141c and 141d to be Va, Vb, Vc and Vd respectively, these are made such that Va<Vb<Vc<Vd. As a result, in the space between first electrode plate 120 and second electrode plate 130, the force which seeks to move charged liquid drops emitted from the nozzle 110 toward the first electrode plate 120 is smaller closer to the nozzle 110 and becomes larger further away from the nozzle 110. As a result, it becomes possible to prevent the matrix solution closer to the nozzle 110 from adhering to a greater extent, which would result in nonuniformities of thickness of the matrix film formed on the sample plate P.

Alternatively, in the configuration shown in FIG. 2, the magnitude of the voltage applied between the electrode plates may be controlled in opposite fashion to that described above, so that the potential difference between the first electrode plate 120 and the second electrode plate 130 will be greater closer to the nozzle 110 and smaller further away from the nozzle 110 (i.e. so that Va>Vb>Vc>Vd). This sort of arrangement is effective for instance in cases where the flow velocity of the spray stream from the nozzle 110 is relatively high and the charged liquid drops cannot readily adhere in the area of the sample plate P near the nozzle 110. Furthermore, the invention is not limited to the above, and one may, for example, make the applied voltage in the direction of the central axis A higher or lower in an area closer to a predetermined region (e.g. near the center) of the sample plate P than in other areas. In these examples, the electrodes 121a through d and 131a through d, the deposition voltage application units 141a through d and the control unit 150 correspond to the electric field intensity difference forming device of the present invention.

In a configuration where the intensity of the electric field over the central axis A of the spray stream is changed depending on the distance from the nozzle 110, it is preferable to provide a film thickness measurement unit 160 capable of measuring the thickness of the matrix film in real time at multiple locations on the sample plate P during film formation and to perform feedback control of the magnitude of voltage applied by each of the deposition voltage application units 141a through d based on the film thickness at each of said measured locations such that the film thickness at each location becomes equal. As the film thickness measurement unit 160, for example, a laser displacement sensor (displacement gauge) capable of measuring the thickness of an object without contact can be used, whereby the thickness of the matrix film can be determined based on the difference between the wavelength of laser light emitted from the laser displacement sensor onto the sample plate P which is reflected by the surface of the matrix film and returns, and the wavelength of laser light which passes through the matrix film and returns after being reflected by the surface of the sample plate P.

Furthermore, while the above example was configured such that the tip end of the nozzle 110 is oriented downward and the first electrode plate 120 and second electrode plate 130 are arranged below the nozzle 110, the orientation of the nozzle 110 in the present embodiment and the positional relationship between the nozzle 110 and the first electrode plate 120 and second electrode plate 130 is not limited thereto, it sufficing for the first electrode plate 120 and second electrode plate 130 to be arranged so as to sandwich the spray stream from the nozzle 110. For example, a configuration may be employed in which the tip end of the nozzle 110 is oriented upward and the first electrode plate 120 and second electrode plate 130 are arranged above the nozzle 110, or a configuration may be employed in which the tip end of the nozzle 110 is oriented laterally (e.g. to the right) and the first electrode plate 120 and second electrode plate 130 are arranged to the right of the nozzle 110.

### Embodiment 2

Next, a matrix film forming device according to a second embodiment of the present invention will be described. FIG. 3 is a diagram of the essential parts of the matrix film forming device according to the present embodiment. For elements which are identical or corresponding to already described elements of the matrix film forming device of the first embodiment (FIG. 1), reference symbols whereof the last two digits are the same will be assigned, and description will be omitted as appropriate.

The matrix film forming device of the present embodiment performs spraying of matrix liquid by the so-called nano-electrospray process, which is one type of electrospray process. In this matrix film forming device, there is no nebulizer gas tube provided in the nozzle 210, and instead, an opposed electrode 270 is provided at a location facing the nozzle 210 so as to sandwich the space between the first electrode plate 220 and the second electrode plate 230. Furthermore, in the matrix film forming device of the present embodiment, in order to prevent the spray stream from the nozzle 210 from stagnating in said space due to the absence of nebulizer gas flow, an evacuation device (not illustrated) comprising a vacuum pump, etc. is provided below the opposed electrode 270. Furthermore, the capillary 211 for spraying the matrix liquid is a fine glass tube coated with a metal thin film, or a fine tube made of metal with a narrowed tip end. Direct current high voltage is applied by spray voltage application unit 215 into the space between this opposed electrode 270 and the capillary 211.

During forming of film with the matrix film forming device of the present embodiment, matrix liquid which has flowed from the matrix liquid supply unit 213 to the tip end of the capillary 211 is charged to some charge (in this example, a positive charge) under the influence of the electric field generated by the voltage applied by the spray voltage application unit 215. Liquid which contains a large amount of ions of the same polarity is thinly stretched out by the action of the electric field formed between the capillary 211 and the opposed electrode 270 due to the voltage applied by this spray voltage application unit 215, forming a circular conical shape called a Taylor cone. As the formation of this Taylor cone progresses, the charge density increases, and at the critical point, a Coulomb explosion occurs and charged drops of the matrix liquid are ejected as microdrops from the tip end of the capillary 211. These microdrops are attracted by the opposed electrode 270 and proceed downward while being finely broken up by the Coulomb repulsive force of the imparted electric charge. As described above, the matrix liquid is sprayed downward from the tip end of the nozzle 210, and the spray stream enters the space between the first electrode plate 220 and the second electrode plate 230 while spreading in a substantially circular conical shape. Here, a direct current voltage is applied between the first electrode plate 220 and the second electrode plate 230 by the deposition voltage application unit 140 so that the first electrode plate 220 side becomes a negative electrode. Thus, the microdrops of the matrix liquid having a positive charge which have entered into said space are attracted toward the first electrode plate 220 under the effect of the electric field formed by this voltage application, leave the flow of the aforesaid spray stream, and adhere to the surface of the sample plate P. On the other hand, neutral particles ejected from the tip end of the capillary 211 along with the ejection of liquid drops of the matrix substance (liquid drops having no electric charge) proceed downward under the effect of gravity and the evacuation device described above without being attracted to the first electrode plate 220, and continue to pass through the aforementioned space, and thus these neutral particles do not adhere to the sample plate P.

In this way, with the matrix film forming device according to the present embodiment, it is possible to deposit only microdrops of charged matrix liquid on the sample plate P, allowing one to form a matrix film with lower content of impurities than in the prior art. Furthermore, here, by having the control unit 250 change the magnitude of the voltage applied by the deposition voltage application unit 240 in accordance with user instructions given via input unit 251, it is also possible to control the maximum size of drops of the matrix liquid made to adhere to the sample plate P (in this case, the control unit 250 corresponds to the liquid drop size adjustment device of the present invention). In this case, the maximum size of drops of the matrix liquid adhering to the sample plate P can be made smaller by making the voltage applied by the deposition voltage application unit 240 smaller.

The present embodiment, just as Embodiment 1 described above, may be configured such that the strength of the electric field formed through application of voltage by the deposition voltage application unit 240 changes according to the distance from the nozzle on the central axis A of the spray stream. An example of such a configuration is shown in FIG. 4.

In this example as well, on the outer surfaces of the first electrode plate 220 and second electrode plate 230 (i.e. the surfaces on the other side from the surfaces which face the spray stream), multiple electrodes 221a through d and 231a through d are attached in a direction parallel to the central axis A of the spray stream, and separate deposition voltage application units 241a through d are provided between the electrodes provided at positions corresponding to the electrode plates 220 and 230, and the magnitude of the voltage applied between the electrodes is controlled by control unit 250 such that the potential difference between the first electrode plate 220 and second electrode plate 230 becomes relatively smaller in the area close to the nozzle 210 (or far from the nozzle, or in the middle) and relatively larger in other areas. It is thereby possible to prevent the occurrence of nonuniformities in matrix film thickness due to more matrix liquid adhering to certain regions of the sample plate P. In this example, the electrodes 221a through d and 231a through d, the deposition voltage application units 241a through d and the control unit 250 correspond to the electric field intensity difference forming device of the present invention.

Furthermore, it is preferable to provide a film thickness measurement unit 260 (e.g. a laser deposition sensor) to measure the thickness of the matrix film in real time, and to perform feedback control of the magnitude of voltage applied by each of the deposition voltage application units 241a through d such that the film thickness at each location becomes equal based on the film thickness at multiple locations measured with the film thickness measurement unit 260.

Modes for embodying the present invention were described above by presenting specific examples; however, the present invention is not limited to the examples described above and allows for any suitable modifications within the gist of the present invention. For example, in above-described Embodiment 1 and Embodiment 2, the first electrode plate and second electrode plate were arranged with their inner surfaces (i.e. the surfaces facing the spray stream produced by the nozzle) parallel to the central axis A of the spray stream, but the invention is not limited to this: for example, as shown in FIG. 5 or FIG. 6, a configuration may be employed wherein the inner surface of the first electrode plate 320 and/or the inner surface of the second electrode plate 330 are tilted in relation to the central axis A (elements which are identical or corresponding to elements already described in FIGS. 1 through 4 will be assigned symbols having the last two digits in common, and description thereof will be omitted as appropriate).

While FIG. 5 and FIG. 6 has a configuration wherein the distance between the first electrode plate 320 and second electrode plate 330 becomes smaller further away from the nozzle 310, one may also employ a configuration wherein, conversely, the distance between the two electrode plates becomes larger further away from the nozzle 310, as shown in FIG. 7 and FIG. 8. In this way, by adopting a configuration in which the first electrode plate 320 and/or the second electrode plate 330 is tilted in relation to the central axis A of the spray stream, it becomes possible to change the potential gradient formed between the two electrode plates 320 and 330 by application of voltage from deposition voltage application unit 340 in accordance with the distance from the nozzle 310 without providing multiple electrodes for the first electrode plate 320 and second electrode plate 330 as described previously. In these examples, the first electrode plate 320 and/or the second electrode plate 330, arranged so as to be tilted with respect to the central axis A of the spray stream, correspond to the electric field intensity difference forming device of the present invention.

In such a case, it is preferable to provide an electrode plate drive unit 380 comprising a motor, etc. for changing the angle of one or both of these electrode plates 320 and 330, and a film thickness measurement unit 360 (e.g. a laser displacement sensor) to measure the matrix film thickness at multiple location on the sample plate P in real time, and to perform feedback control of the operation of the electrode plate drive unit 380 during execution of film forming such that the film thickness will be equal at each location based on the film thicknesses measured by the film thickness measurement unit 360. In this case, the first electrode plate 320 and/or the second electrode plate 330, arranged so as to be tilted with respect to the central axis A of the spray stream, the electrode plate drive unit 380 and the control unit 350 correspond to the electric field intensity difference forming device of the present invention.

### DESCRIPTION OF REFERENCES

110, 210, 310 . . . Nozzle
111, 211 . . . Capillary
112 . . . Nebulizer gas tube
113, 213, 313 . . . Matrix liquid supply unit
114, 314 . . . Nebulizer gas supply unit
115, 215, 315 . . . Spray voltage application unit
120, 220, 320 . . . First electrode plate
130, 230, 330 . . . Second electrode plate
121a through d, 131a through d, 221a through d, 231a through d . . . Electrode
140, 141a through d, 240, 241a through d, 340 . . . Deposition voltage application unit
150, 250, 350 . . . Control unit
151, 251, 351 . . . Input unit
160, 260, 360 . . . Film thickness measurement unit
270 . . . Opposed electrode
380 . . . Electrode plate drive unit
A . . . Central axis of spray stream
P . . . Sample plate

What is claimed:

1. A matrix film forming device for forming a film containing a matrix substance on the surface of a sample plate, comprising:
a) a first electrode plate comprising a mounting surface on which said sample plate is mounted;
b) a second electrode plate arranged so as to face said mounting surface;
c) a nozzle which sprays a liquid containing a matrix substance by an electrospray process into the space between said first electrode plate and said second electrode plate, and which is arranged such that said first electrode plate and said second electrode plate are not present over the central axis of the spray stream; and
d) an electric field forming device which forms an electric field between said first electrode plate and said second electrode plate so as to cause drops of liquid containing said matrix substance, which have been electrically charged and are contained in said spray stream, to move toward said mounting surface.

2. The matrix film forming device as described in claim 1, characterized in that said nozzle comprises
e) a capillary having a tubular shape, through which liquid containing said matrix substance flows from the base end side toward a liquid drop spray opening provided on the tip end side; and
f) a nebulizer gas ejection channel which is a channel running parallel to said capillary and through which nebulizer gas is ejected in the vicinity of said liquid drop spray opening,
the matrix film forming device further comprising
g) a voltage application device which applies a direct current voltage to said capillary.

3. The matrix film forming device as described in claim 1, characterized in that said nozzle comprises
h) a capillary having a tubular shape, through which liquid containing said matrix substance flows from the base end side toward a liquid drop spray opening provided on the tip end side,
the matrix film forming device further comprising
i) an opposed electrode arranged at a position opposite the tip end of said nozzle; and
j) a voltage application device which applies a direct current voltage between said capillary and said opposed electrode.

4. The matrix film forming device as described in claim 1, further comprising
k) an electric field intensity difference forming device which changes the intensity of said electric field over the central axis of said spray stream in accordance with the distance from the tip end of said nozzle.

5. A matrix film forming device as described in claim 1, further comprising
l) a liquid drop size adjustment device which adjusts the size of drops of liquid containing said matrix substance which adhere to said sample plate by changing the potential difference between said first electrode plate and said second electrode plate.

6. A matrix film forming device as described in claim 2, further comprising
l) a liquid drop size adjustment device which adjusts the size of drops of liquid containing said matrix substance which adhere to said sample plate by changing the potential difference between said first electrode plate and said second electrode plate.

7. A matrix film forming device as described in claim 3, further comprising
l) a liquid drop size adjustment device which adjusts the size of drops of liquid containing said matrix substance which adhere to said sample plate by changing the potential difference between said first electrode plate and said second electrode plate.

8. A matrix film forming device as described in claim 4, further comprising
1) a liquid drop size adjustment device which adjusts the size of drops of liquid containing said matrix substance which adhere to said sample plate by changing the potential difference between said first electrode plate and said second electrode plate.

9. The matrix film forming device as described in claim 2, further comprising
k) an electric field intensity difference forming device which changes the intensity of said electric field over the central axis of said spray stream in accordance with the distance from the tip end of said nozzle.

10. The matrix film forming device as described in claim 3, further comprising
k) an electric field intensity difference forming device which changes the intensity of said electric field over the central axis of said spray stream in accordance with the distance from the tip end of said nozzle.

11. A method of forming a matrix film containing a matrix substance on the surface of a sample plate, comprising:
a) mounting a sample plate on a mounting surface of a first electrode plate;
b) arranging a second electrode plate to face said mounting surface;
c) spraying by a nozzle a liquid containing a matrix substance by an electrospray process into the space between said first electrode plate and said second electrode plate, such that said first electrode plate and said second electrode plate are not present over the central axis of the spray stream; and
d) forming an electric field between said first electrode plate and said second electrode plate so as to cause drops of liquid containing said matrix substance, which have been electrically charged and are contained in said spray stream, to move toward said mounting surface.

12. The method of forming the matrix film as described in claim 11, further comprising
k) changing the intensity of said electric field over the central axis of said spray stream in accordance with the distance from the tip end of said nozzle.

13. The method of forming the matrix film as described in claim 11, further comprising
l) adjusting the size of drops of liquid containing said matrix substance which adhere to said sample plate by changing the potential difference between said first electrode plate and said second electrode plate.

14. The method of forming the matrix film as described in claim 12, further comprising
l) adjusting the size of drops of liquid containing said matrix substance which adhere to said sample plate by changing the potential difference between said first electrode plate and said second electrode plate.
